(19) United States
(12) Patent Application Publication
(10) Pub. No.: US 2024/0161096 A1
(43) Pub. Date: May 16, 2024

(54) SYSTEMS, METHODS, AND APPARATUSES FOR ELECTRONIC AUTHORIZATION FOR TRANSFER OF AN ELECTRONIC RESOURCE

(71) Applicant: BANK OF AMERICA CORPORATION, Charlotte, NC (US)

(72) Inventors: Alejandra Magiella Wessolossky Guzman, Jacksonville, FL (US); Joseph Benjamin Castinado, North Glenn, CO (US)

(73) Assignee: BANK OF AMERICA CORPORATION, Charlotte, NC (US)

(21) Appl. No.: 17/984,352

(22) Filed: Nov. 10, 2022

(51) Int. Cl. G06Q 20/38; G06Q 20/22; G06Q 20/40

(52) U.S. Cl. CPC G06Q 20/3825; G06Q 20/227; G06Q 20/4014

(57) ABSTRACT

Systems, computer program products, and methods are described herein for electronic authorization for transfer of an electronic resource. The present disclosure is configured to generate an electronic copy of a resource distribution instrument, wherein the resource distribution instrument identifies a recipient account; transmit an electronic authorization request to a device associated with a resource distribution, wherein the device associated with the resource distribution is a device associated with a recipient user of the recipient user account; receive an electronic authorization response from the user device associated with the recipient user, wherein the electronic authorization response comprises at least one of an electronic signature or a captured physical characteristic; and generate an authorization of the resource distribution instrument based on the electronic authorization response.

### TECHNOLOGICAL FIELD

Example embodiments of the present disclosure relate to electronic authorizations for transfer of electronic resources.

### BACKGROUND

Recipient users of a resource distribution instrument have a more difficult time than ever authorizing resource distribution instruments over electronic networks. Similar to the need for the recipient user to authorize the resource distribution instrument over the electronic network, there exists a need for the entity associated with the recipient user account to authorize and verify the identity of the recipient user when a resource distribution instrument is input over the electronic network. A need, therefore, exists for a system to accurately, efficiently, and securely authorize electronic transfers of an electronic resource based on the authorization of a resource distribution instrument, over an electronic network.

Applicant has identified a number of deficiencies and problems associated with the electronic authorization for transfer of electronic resources. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for electronic authorizations for transfer of electronic resources.

In one aspect, a system for electronic authorization for transfer of an electronic resource is provided. The system may comprise: a memory device with computer-readable program code stored thereon; at least one processing device operatively coupled to the at least one memory device and the at least one communication device, wherein executing the computer-readable code is configured to cause the at least one processing device to: generate an electronic copy of a resource distribution instrument, wherein the resource distribution instrument identifies a recipient account; transmit an electronic authorization request to a device associated with a resource distribution, wherein the device associated with the resource distribution is a device associated with a recipient user of the recipient user account; receive an electronic authorization response from the user device associated with the recipient user, wherein the electronic authorization response comprises at least one of an electronic signature or a captured physical characteristic; and generate an authorization of the resource distribution instrument based on the electronic authorization response.

In some embodiments, the processing device is further configured to: capture an image of the resource distribution instrument, wherein the capturing of the image of the resource distribution instrument is completed by at least one of the device associated with the recipient user or a resource distribution machine; and generate, based on the captured image, the electronic copy of the resource distribution instrument.

In some embodiments, the processing device is further configured to: query, based on the recipient user account, a user account database to determine at least one verified electronic authorization response of the recipient user; compare the electronic authorization response to the at least one verified electronic authorization response; and authenticate, based on the comparison of the electronic authorization response to the verified electronic authorization response, the electronic authorization response for the resource distribution instrument.

In some embodiments, the electronic authorization response further comprises a geolocation identifier. In some embodiments, the geolocation identifier comprises a geolocation of the device associated with the resource distribution at a time when the electronic copy of the resource distribution instrument is generated. In some embodiments, the processing device is further configure to: query, based on the recipient user account, a user account database to determine at least one verified geolocation identifier associated with the recipient user; compare the geolocation identifier to the at least one verified geolocation identifier; and authenticate, based on the comparison of the geolocation identifier to the verified geolocation identifier, the electronic authorization response for the resource distribution instrument.

In some embodiments, the electronic authorization response is captured by at least one of an imaging device associated with the user device, an imaging device associated with the resource distribution machine, a physical characteristic scanning device associated with the user device, a physical characteristic scanning device associated with the resource distribution machine, a signature application associated with the user device, a signature application associated with the resource distribution machine, or a signature capture device associated with the resource distribution machine.

In another aspect, a computer program product for electronic authorization for transfer of an electronic resource is provided. In some embodiments, the computer program product comprises at least one non-transitory computer-readable medium having computer-readable program code portions embodied therein, the computer-readable program code portions which when executed by a processing device are configured to cause the processor to: generate an electronic copy of a resource distribution instrument, wherein the resource distribution instrument identifies a recipient account; transmit an electronic authorization request to a device associated with a resource distribution, wherein the device associated with the resource distribution is a device associated with a recipient user of the recipient user account; receive an electronic authorization response from the user device associated with the recipient user, wherein the electronic authorization response comprises at least one of an electronic signature or a captured physical characteristic; and generate an authorization of the resource distribution instrument based on the electronic authorization response.

In some embodiments, the processing device is further configured to cause the processor to: capture an image of the resource distribution instrument, wherein the capturing of the image of the resource distribution instrument is completed by at least one of the device associated with the recipient user or a resource distribution machine; and generate, based on the captured image, the electronic copy of the resource distribution instrument.

In some embodiments, the processing device is further configured to cause the processor to: query, based on the recipient user account, a user account database to determine at least one verified electronic authorization response of the recipient user; compare the electronic authorization response to the at least one verified electronic authorization response; and authenticate, based on the comparison of the electronic authorization response to the verified electronic authorization response, the electronic authorization response for the resource distribution instrument.

In some embodiments, the electronic authorization response further comprises a geolocation identifier. In some embodiments, the geolocation identifier comprises a geolocation of the device associated with the resource distribution at a time when the electronic copy of the resource distribution instrument is generated. In some embodiments, the processing device is further configured to cause the processor to: query, based on the recipient user account, a user account database to determine at least one verified geolocation identifier associated with the recipient user; compare the geolocation identifier to the at least one verified geolocation identifier; and authenticate, based on the comparison of the geolocation identifier to the verified geolocation identifier, the electronic authorization response for the resource distribution instrument.

In some embodiments, the electronic authorization response is captured by at least one of an imaging device associated with the user device, an imaging device associated with the resource distribution machine, a physical characteristic scanning device associated with the user device, a physical characteristic scanning device associated with the resource distribution machine, a signature application associated with the user device, a signature application associated with the resource distribution machine, or a signature capture device associated with the resource distribution machine.

In another aspect, a computer-implemented method for electronic authorization for transfer of an electronic resource is provided. In some embodiments, the computer-implemented method comprises: generating an electronic copy of a resource distribution instrument, wherein the resource distribution instrument identifies a recipient account; transmitting an electronic authorization request to a device associated with a resource distribution, wherein the device associated with the resource distribution is a device associated with a recipient user of the recipient user account; receiving an electronic authorization response from the user device associated with the recipient user, wherein the electronic authorization response comprises at least one of an electronic signature or a captured physical characteristic; and generating an authorization of the resource distribution instrument based on the electronic authorization response.

In some embodiments, the computer-implemented method further comprises: capturing an image of the resource distribution instrument, wherein the capturing of the image of the resource distribution instrument is completed by at least one of the device associated with the recipient user or a resource distribution machine; and generating, based on the captured image, the electronic copy of the resource distribution instrument.

In some embodiments, the computer-implemented method further comprises: querying, based on the recipient user account, a user account database to determine at least one verified electronic authorization response of the recipient user; comparing the electronic authorization response to the at least one verified electronic authorization response; and authenticating, based on the comparison of the electronic authorization response to the verified electronic authorization response, the electronic authorization response for the resource distribution instrument.

In some embodiments, the electronic authorization response further comprises a geolocation identifier. In some embodiments, the geolocation identifier comprises a geolocation of the device associated with the resource distribution at a time when the electronic copy of the resource distribution instrument is generated. computer-implemented method further comprises: querying, based on the recipient user account, a user account database to determine at least one verified geolocation identifier associated with the recipient user; comparing the geolocation identifier to the at least one verified geolocation identifier; and authenticating, based on the comparison of the geolocation identifier to the verified geolocation identifier, the electronic authorization response for the resource distribution instrument.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for electronic authorizations for transfer of electronic resources, in accordance with an embodiment of the disclosure;

FIG. 2 illustrates a process flow for electronic authorizations for transfer of electronic resources, in accordance with an embodiment of the disclosure, in accordance with an embodiment of the disclosure;

FIG. 3 illustrates a process flow for generating an electronic copy of the resource distribution instrument, in accordance with an embodiment of the disclosure;

FIG. 4 illustrates a process flow for authenticating the electronic authorization response for the resource distribution instrument based on a verified electronic authorization response, in accordance with an embodiment of the disclosure; and

FIG. 5 illustrates a process flow for authenticating the electronic authorization response for the resource distribution instrument based on a verified geolocation identifier, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

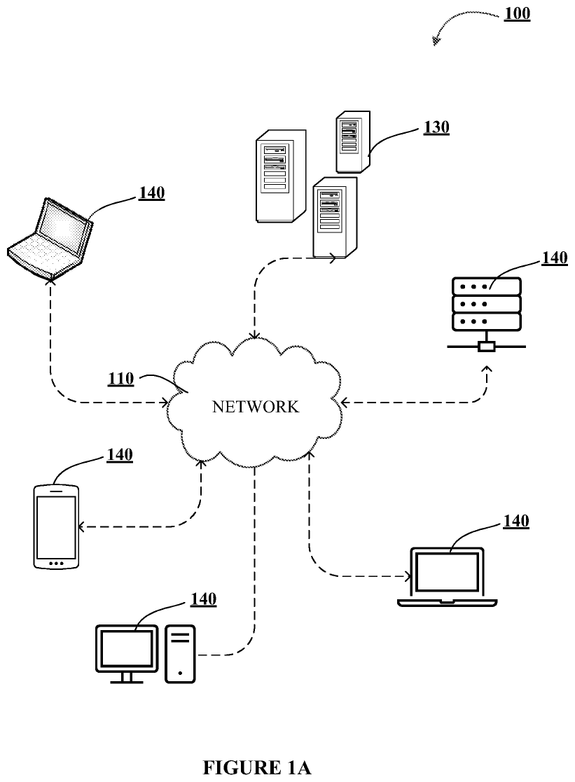

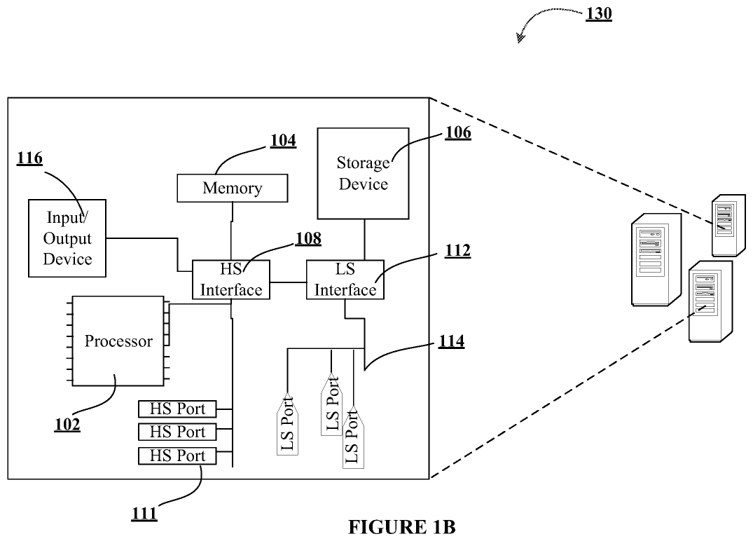

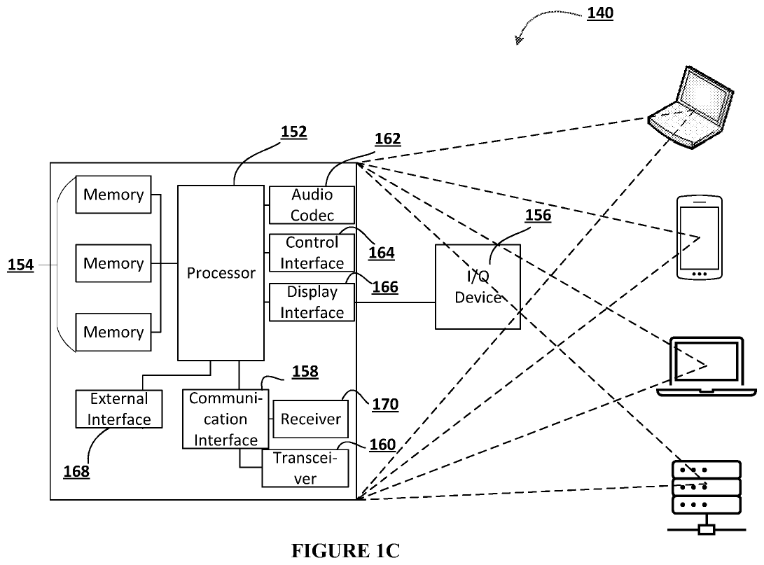

As described in further detail herein, the present invention provides a solution to the above-referenced problems in the field of technology by generating an accurate, efficient, and secure authorization system for the transfer of electronic resources. Such a system (i.e., an authorization system) may generate an authorization of the resource distribution instrument based on an electronic authorization response received from a recipient user. The present invention solves the technical problem of prior systems' inability of accurately, efficiently, and securely authorizing recipient users and their associated resource distribution instruments over electronic networks. The present invention solves this technical problem by implementing the authorization system, like that shown as system 130 in FIGS. 1A-1C. For instance, the authorization system acts to generate an electronic copy of the resource distribution instrument, request an electronic authorization response from the recipient user associated with the resource distribution instrument, receive the electronic authorization response from the recipient user, and authorize the resource distribution instrument based on the electronic authorization response. In some embodiments, the authorization system may further be configured to authenticate the electronic authorization response based on at least one geolocation identifier of the generation of the electronic copy of the resource distribution instrument and/or based on at least one verified electronic authorization response associated with the recipient user account.

Accordingly, the authorization system works by generating an electronic copy of a resource distribution instrument, where the resource distribution instrument identifies a recipient account; transmitting an electronic authorization request to a device associated with a resource distribution, where the device associated with the resource distribution is a device associated with a recipient user of the recipient user account; and receiving an electronic authorization response from the user device associated with the recipient user, where the electronic authorization response comprises at least one of an electronic signature or a captured physical characteristic. The authorization system may further generate, based on the electronic authorization response, an authorization of the resource distribution instrument.

What is more, the present disclosure provides a technical solution to a technical problem. As described herein, the technical problem includes the inability of prior systems in accurately, efficiently, and securely authorizing a resource distribution instrument over an electronic network. The technical solution presented herein allows for the accurate, efficient, and secure authorization of resource distribution instruments over an electronic network by way of an authorization system. In particular, the authorization system is an improvement over existing solutions for remotely authorizing resource distribution instruments, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

FIGS. 1A-1C illustrate technical components of an exemplary distributed computing environment for electronic authorizations for transfer of electronic resources 100, in accordance with an embodiment of the invention. As shown in FIG. 1A, the distributed computing environment 100 contemplated herein may include a system 130 (i.e., an authorization system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

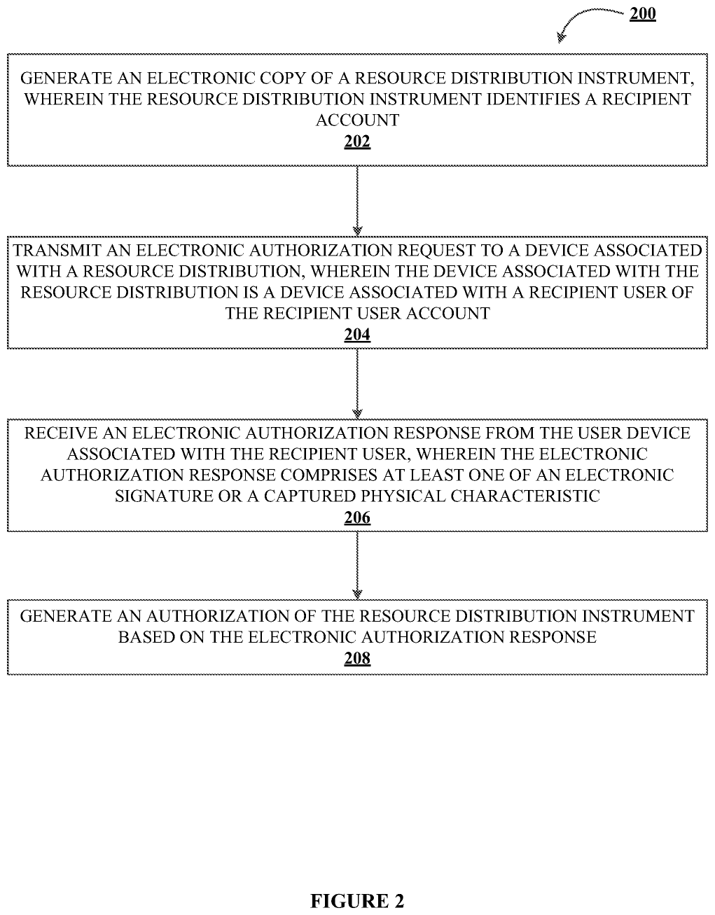

FIG. 2 illustrates a process flow 200 for electronic authorizations for transfer of electronic resources, in accordance with an embodiment of the invention. In some embodiments, a system (e.g., similar to one or more of the systems described herein with respect to FIGS. 1A-1C) may perform one or more of the steps of process flow 200. For example, an authorization system (e.g., the system 130 described herein with respect to FIG. 1A-1C) may perform the steps of process 200.

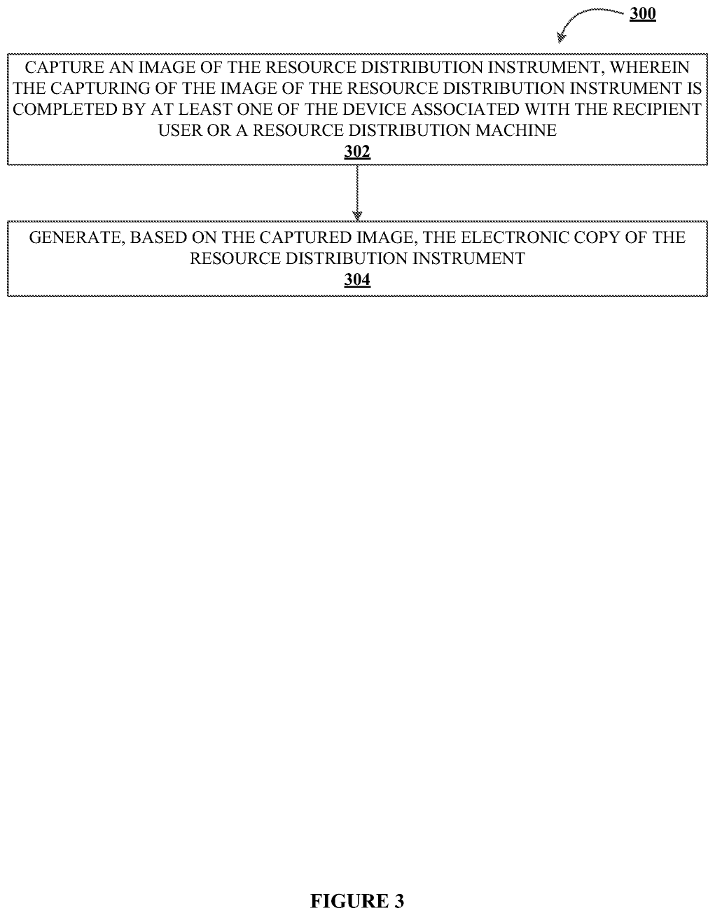

As shown in block 202, the process flow 200 may include the step of generating an electronic copy of a resource distribution instrument, wherein the resource distribution instrument identifies a recipient account. By way of non-limiting example, the authorization system may generate an electronic copy of a resource distribution instrument by capturing an image of the resource distribution instrument such as through the use of a camera or other image-capturing device, by scanning the resource distribution instrument such as through the use of a light sensor array attached to a scan head inside a device associated with a resource distribution machine or a user device associated with the recipient account, and/or the like. The generation of an electronic copy of the resource distribution instrument is described in more detail below with respect to FIG. 3.

As shown in block 204, the process flow 200 may include the step of transmitting an electronic authorization request to a device associated with a resource distribution, wherein the device associated with the resource distribution is a device associated with a recipient user of the recipient user account. In some embodiments, the authorization system may generate an electronic authorization request comprising a request for a recipient user of the recipient user account to complete. In some embodiments, such an electronic authorization request may comprise a request for the recipient user to generate an electronic signature using the device associated with the recipient user (i.e., a device which is accessing the recipient user account such as, for example, a recipient user device, a resource distribution machine accessing the recipient user account, and/or the like). For instance, the authorization system may generate a n electronic authorization request comprising a request for the recipient user to input an electronic signature into the authorization system. In some embodiments, the electronic authorization request may comprise an indication that if the recipient user does complete the electronic authorization request, the authorization system would determine the electronic authorization response from the recipient user to be an approval of the resource distribution instrument (e.g., the recipient user approves of the resource distribution value indicated by the resource distribution instrument which would be distributed to the recipient user's account).

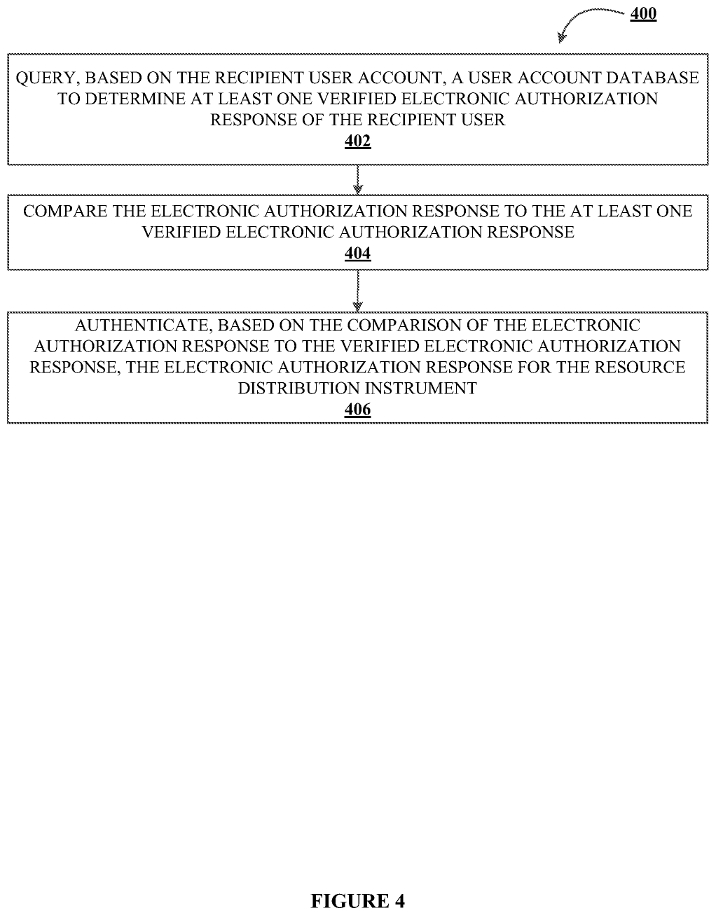

In some embodiments, the authorization system may comprise a signature pad and/or other such device to capture an electronic signature of the recipient user (e.g., a touch screen on a configured graphical user device of the recipient, and/or the like), which the recipient user may use to input an electronic signature into the authorization system. In some embodiments, the authorization system may compare the electronic signature captured by the authorization system against at least one previously captured electronic signature generated by the recipient user, which may be stored in a database of the authorization system (e.g., such as a user account database). The user account database and the comparison of electronic signatures are described in further detail below with respect to FIG. 4.

In some embodiments, the authorization system may generate an electronic authorization request comprising a request or an indication for the recipient user to complete transmit an electronic authorization response comprising an electronic copy physical characteristic of the recipient user. For instance, the authorization system may request that the recipient user submit a scanning or an image of a physical characteristic (e.g., a scanning or image of the recipient user's eye, a scanning or image of the recipient user's fingerprint, a scanning or image of the recipient user's face) which may be compared against previously captured physical characteristic(s) of the recipient user. Such a comparison is described in further detail below with respect to FIG. 4.

In some embodiments, the authorization system may transmit an electronic authorization request comprising a plurality of types of electronic authorization responses that the recipient user may use to authorize the electronic copy of the resource distribution instrument. For instance, the authorization system may transmit the electronic authorization request which may allow the recipient user to choose an electronic authorization response type (e.g., electronic signature, an electronic copy of a physical characteristic, and/or the like) to transmit to the authorization system.

As shown in block 206, the process flow 200 may include the step of receiving an electronic authorization response from the user device associated with the recipient user, wherein the electronic authorization response comprises at least one of an electronic signature and/or a captured physical characteristic. By way of non-limiting example, the authorization system may receive the electronic authorization response which may further comprise at least one of an electronic signature, one of a captured physical characteristic, and/or the like. In some embodiments, the electronic authorization response may be captured by at least one of an imaging device associated with the user device, an imaging device associated with a resource distribution machine (e.g., an automated teller machine comprising a camera or scanning device), a physical characteristic scanning device associated with the user device, a physical characteristic scanning device associated with the resource distribution machine, a signature application associated with the user device, a signature application associated with the resource distribution machine, or a signature capture device (e.g., a signature pad) associated with the resource distribution machine.

As shown in block 208, the process flow 200 may include the step of generating an authorization of the resource distribution instrument based on the electronic authorization response. In some embodiments, the authorization system may generate the authorization of the resource distribution instrument based on the receipt of the electronic authorization response. For instance, the authorization system may accept the electronic authorization response generated by the recipient user (e.g., from a recipient user device or a device associated with a recipient user account such as a resource distribution machine having access to the recipient user account) and generate the authorization of the resource distribution instrument. Such an authorization of the resource distribution may comprise a generation of a combination of the electronic copy of the resource distribution instrument and the electronic authorization response. For instance, and where the electronic authorization response comprises an electronic signature, the authorization system may attach and/or place a rendering of the electronic signature on the electronic copy of the resource distribution instrument to generate an authorized resource distribution instrument. Such an authorized resource distribution instrument may be saved by the authorization system, such as in memory 104, storage device 106 memory 154. In some embodiments, the electronic authorization response may be saved by the authorization system to a user account database and specifically saved to a dataset of previously stored electronic authorization responses of the recipient user account, such that at least one previously stored electronic authorization response may be used for comparison of a recently received electronic authorization response.

FIG. 3 illustrates a process flow 300 for generating an electronic copy of the resource distribution instrument based, in accordance with an embodiment of the invention. In some embodiments, a system (e.g., similar to one or more of the systems described herein with respect to FIGS. 1A-1C) may perform one or more of the steps of process flow 300. For example, an authorization system (e.g., the system 130 described herein with respect to FIG. 1A-1C) may perform the steps of process 300.

As shown in block 302, the process flow 300 may include the step of capturing an image of the resource distribution instrument, wherein the capturing of the image of the resource distribution instrument is completed by a device associated with recipient user or a resource distribution machine. In some embodiments, the authorization system may capture an image of the resource distribution instrument by a device associated with the recipient user (e.g., a mobile device of the recipient user, a personal computing device of the recipient user, and/or the like) or a device which is able to access the recipient user account such as a resource distribution machine, and/or the like.

As used herein, a “resource distribution machine” may refer to a machine used for at least one resource distribution such as an Automated Teller Machine (“ATM”), resource transaction device, terminal, kiosk, financial institution device or terminal, a device comprising a financial institution configured graphical user interface, and/or the like. Specifically, the resource distribution machine may, at a specific time where a resource is requested to be distributed from a user's account, will distribute resources from the user's account. By way of non-limiting example, the device associated with the recipient user which is used to capture the image of the resource distribution instrument has at least one component (e.g., a camera, an image-capturing device, a scanning device, and/or the like) which may capture an image or scan a copy of the resource distribution instrument to generate the electronic copy of the resource distribution instrument.

As shown in block 304, the process flow 300 may include the step of generating, based on the captured image, the electronic copy of the resource distribution instrument. In some embodiments, the authorization system may generate, based on the captured image of the resource distribution instrument, the electronic copy of the resource distribution instrument to be an exact copy of the resource distribution instrument, but in electronic form. Such an electronic copy of the resource distribution instrument may comprise each of the details included on the face of the resource distribution instrument (e.g., the surfaces of the resource distribution instrument). For instance, and where the resource distribution instrument is a check (e.g., such as a check generated by a financial institution and filled out by a user associated with the account identified on the surface of the check), the authorization system may capture and/or generate an electronic copy of each surface of the check, including each text field of the check (e.g., both on the front and the back surface). In some embodiments, the electronic copy of the resource distribution instrument may similarly (similar to the resource distribution instrument) indicate the recipient user for which the resource distribution instrument is intended to transmit resources, a sender user account from which the resources are to be distributed from, a date for the resource distribution (e.g., a first date which a resource distribution may be allowed), a sender user signature, a resource distribution amount (e.g., in at textual format, a numerical format, and/or the like), a memorandum text field, an authorization field for the recipient user (e.g., an authorization section for the recipient user to sign), and/or the like. Based on at least the fields listed above, the electronic copy of the resource distribution instrument may further indicate each of the fields in the generated and/or captured electronic copy.

FIG. 4 illustrates a process flow 400 for authenticating the electronic authorization response for the resource distribution instrument based on a verified electronic authorization response, in accordance with an embodiment of the invention. In some embodiments, a system (e.g., similar to one or more of the systems described herein with respect to FIGS. 1A-1C) may perform one or more of the steps of process flow 400. For example, an authorization system (e.g., the system 130 described herein with respect to FIG. 1A-1C) may perform the steps of process 400.

As shown in block 402, the process flow 400 may include the step of querying, based on the recipient user account, a user account database to determine at least one verified electronic authorization response of the recipient user. In some embodiments, the authorization system may receive a recipient user account identifier based on the identification of a recipient user identified on the resource distribution instrument (e.g., by a name of the recipient user, by an account number of the recipient user, and/or by the recipient user submitting or entering the resource distribution instrument to a device associated with the recipient user account such as an resource distribution machine or a recipient user device associated with the recipient user account).

In some embodiments, and based on the recipient user account, the recipient user identifier may be used by the authorization system to query a user account database to determine at least one verified electronic authorization response of the recipient user. For instance, the user account database may comprise and store each of the verified electronic authorization responses previously received from at least the recipient user. In this manner, the user account database may comprise each of the verified electronic authorization responses for each recipient user across the authorization system. Upon determining and/or receiving the recipient user account identifier associated with a resource distribution instrument, the authorization system may input the recipient user account identifier into the user account database to query the user account database to find and/or output the verified electronic authorization responses for the specific recipient user account identifier.

By way of non-limiting example, the verified electronic responses may comprise previously verified physical characteristics of the recipient user such as but not limited to the recipient user's eyes (e.g., by way of scanning or imaging the recipient user's eyes to determine iris patterns and colors in the recipient user's eyes), the recipient user's fingerprints (e.g., by way of scanning or imaging the recipient fingerprints), the recipient user's face (e.g., by way of scanning or imaging the recipient user's facial features and feature points such as the location of the recipient user's eyes, eyebrows, nose, mouth, chin, ears, and/or the like), and/or the like. In some embodiments, the verified electronic responses may comprise previously verified signatures of the recipient user such as but not limited to electronic signatures of the recipient user which were signed by the recipient user where the recipient user may have used specific technology to sign—such as a signature pad—for previous resource distribution instruments or electronic documents; signatures signed by the recipient user on a touchscreen for previous resource distribution instruments or electronic documents; signatures signed by the recipient user using a mouse or trackpad for previous resource distribution instruments or electronic documents; signatures signed by typing in using a keyboard; and/or the like.

In some embodiments and based on this querying of the recipient user account identifier in the user account database, the authorization system may use the previous verified electronic authorization responses to authenticate a recently received electronic authorization response. Such a process is described below with respect to blocks 404 and 406.

As shown in block 404, the process flow 400 may include the step of comparing the electronic authorization responses to the at least one verified electronic authorization response. By way of non-limiting example, the authorization system may compare at least one of the verified electronic authorization responses from the user account database against the recently received electronic authorization response received for the electronic copy of the resource distribution instrument.

In some embodiments, the comparison of the verified electronic authorization responses and electronic authorization response may refer to the determination of similarities and differences between the verified electronic authorization response and the recently received electronic authorization response. Such a comparison of the verified electronic authorization response and the recently received electronic authorization response should comprise the same type of electronic authorization response (e.g., the verified electronic authorization response and the electronic authorization response should both comprise an electronic signature or should both comprise a certain physical characteristic of the recipient user such as an eye/iris scan or image, a fingerprint scan or image, a facial scan or image, and/or the like).

As shown in block 406, the process flow 400 may include the step of authenticating, based on the comparison of the electronic authorization response to the verified electronic authorization response, the electronic authorization response for the resource distribution instrument. In some embodiments, the authorization system may authenticate the electronic authorization response received for the resource distribution instrument by comparing the electronic authorization response against at least one verified electronic authorization response of the same type. In some embodiments and where the user account database comprises a plurality of verified electronic authorization responses of the same type for the recipient user, the authorization system may use the most recently received verified electronic authorization responses of the recipient user. In this manner, the authorization system may account for changes and or updates to the recipient user's electronic signature, physical characteristics (e.g., changes to the recipient user's eyes or irises, changes to the recipient user's fingerprint(s), changes to the recipient user's face, and/or the like) in authenticating the electronic authorization response.

In some embodiments, the authorization system may compare a plurality of the most recently verified electronic authorization responses of the same type to the electronic authorization response, where the plurality of the most recently verified electronic authorization responses which are compared are determined by the authorization system based on a predetermined time period (e.g., only those verified electronic authorization responses of the same type from the past month, from the past six months, from the past year, and/or the like). By way of non-limiting example, the electronic authorization response may be compared individually to each of the plurality of the most recently received electronic authorization responses of the same type in order to determine the overall similarities and differences, or to determine the similarities and differences between what appears to be the most similar of the plurality of the most recently verified electronic authorization responses to the most recently received electronic authorization response.

By way of non-limiting example, and during the authentication of the electronic authorization responses, the authorization system may combine and/or integrate the electronic authorization response from the recipient user for the resource distribution instrument with the electronic copy of the resource distribution instrument, such that the electronic authorization response and the electronic copy of the resource distribution instrument are saved in a single file.

In some embodiments, and based on the generation of the single file comprising the electronic authorization response and the electronic copy of the resource distribution instrument, the authorization system may transmit the single file to an authentication entity or group within a resource entity associated with the recipient user (e.g., an authentication group within a financial institution associated with the recipient user), such that the authentication group may separately verify the electronic authorization response as being from the recipient user. In some embodiments, the authentication group may compare the previously received verified electronic authorization responses against the electronic authorization response to determine whether the electronic authorization response is acceptable and verified (e.g., the electronic authorization response fits clarity parameters such as being clear and easily discernable, and matches within a verified threshold of previously verified electronic authorization responses). Such a verified threshold may be predetermined by the authentication group, the entity associated with the authentication group (e.g., the financial institution), and/or the like.

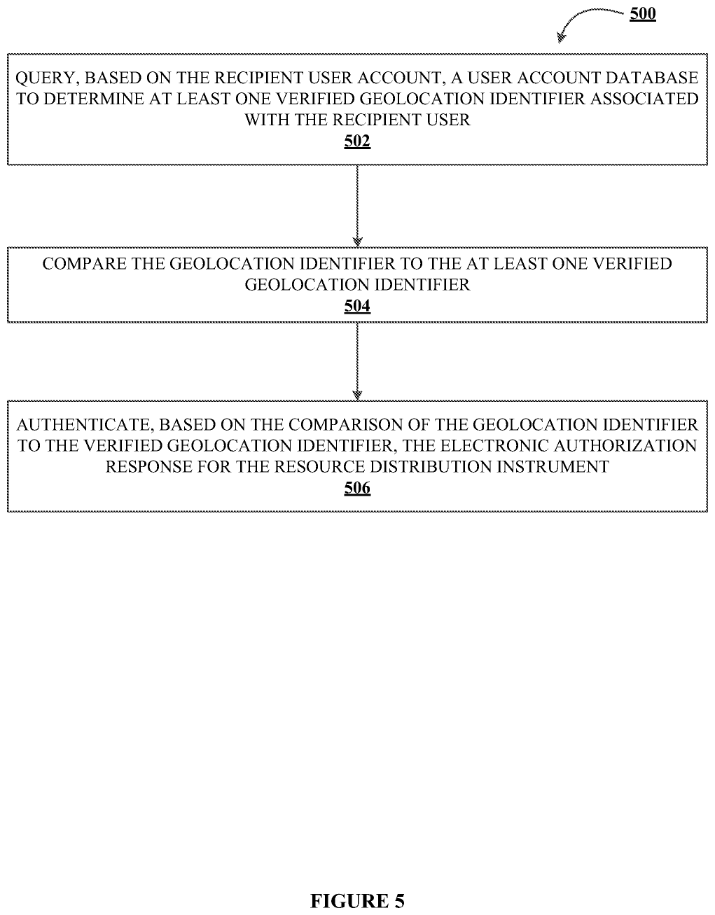

FIG. 5 illustrates a process flow 500 for authenticating the electronic authorization response for the resource distribution instrument based on a verified geolocation identifier, in accordance with an embodiment of the invention. In some embodiments, a system (e.g., similar to one or more of the systems described herein with respect to FIGS. 1A-1C) may perform one or more of the steps of process flow 500. For example, an authorization system (e.g., the system 130 described herein with respect to FIG. 1A-1C) may perform the steps of process 500.

As shown in block 502, the process flow 500 may include the step of querying, based on the recipient user account, a user account database to determine at least one verified geolocation identifier associated with the recipient user. In some embodiments, the authorization system may query, based on the recipient user account and/or recipient user account identifier associated with the recipient user account, the user account database for authenticating the electronic authorization response. In some embodiments, the authorization system may receive a geolocation identifier for each electronic authorization response of the recipient user, where the geolocation identifier may be based on the location of the device (e.g., recipient user device, resource distribution machine, and/or the like) used to generate the electronic authorization response. In this manner, the authorization system may comprise geolocation tracking abilities (and or the device associated with the electronic authorization response comprises geolocation tracking technology, such as a mobile device associated with the recipient user which may comprise a global positioning system (GPS)). In some embodiments, and where the device associated with electronic authorization responses is a resource distribution machine which is only located at single, non-moving location, such as an automated teller machine, point of sale machine, and/or the like, the geolocation identifier may remain the same for each of the electronic authorization responses generated and/or captured at the resource distribution machine.

In some embodiments, the geolocation identifier may be generated and/or captured at the time the electronic copy of the resource distribution instrument is generated and/or captured. For instance, and where the electronic copy is generated by capturing an image of the resource distribution instrument or scanning an image of the resource distribution instrument, the authorization system may likewise capture data regarding the current location of the device associated with the generation of the electronic copy.

In some embodiments, the authorization system may store each of the previously received verified geolocation identifiers for each of the recipient user accounts associated with the authorization system. In this manner, the authorization system may have a complete database within the user account database of each of the recipient user accounts and their associated data (e.g., previously received and verified electronic authorization responses, previously received and verified geolocation identifiers, and/or the like). In some embodiments, the previously verified geolocation identifiers may be verified based on each acceptance or authentication of the previous electronic authorization responses associated with each verified geolocation identifier. For instance, upon the authorization system authorizing and/or authenticating each previous electronic authorization response (e.g., which would in turn create a verified electronic authorization response), the authorization system may generate the verified geolocation identifier based on the received geolocation identifier for the previous electronic authorization response.

As shown in block 504, the process flow 500 may include the step of comparing the geolocation identifier to the at least one verified geolocation identifier. In some embodiments, the authorization system may compare the received geolocation identifier for the resource distribution instrument against at least one verified geolocation identifier of the recipient user account. By way of non-limiting example, the comparison of the geolocation identifier and the verified geolocation identifier (e.g., at least one verified geolocation identifier) may comprise a determination of whether the geolocation identifier and at least verified geolocation identifier exactly match. As used herein, the geolocation identifier may refer to a unique set of numerical values, letter values, symbols, variables, and/or the like which uniquely identify a geolocation of a device (e.g., a recipient user device, a resource distribution machine, and/or the like). In some embodiments, the authorization system may require an exact matching of at least one verified geolocation identifiers associated with the recipient user account such that the exact matching may indicate that the recipient user is using the same device and/or the same location as previously used for previous electronic authorization responses and the authorization of the associated resource distribution instruments.

In some embodiments, the authorization system may require a comparison which shows the geolocation identifier of the electronic copy of the resource distribution instrument is in a similar location to previous verified geolocation identifiers. For instance, where the geolocation identifier is within a threshold radius to at least one verified geolocation identifier, such where the geolocation identifier is within the same region of at least one previous verified geolocation identifier (e.g., same town, same county, same state, same country, and/or the like), then the authorization system may determine the geolocation identifier can be used to authenticate the electronic authorization response from the recipient user.

In some embodiments, the geolocation identifier (and its verification based on previous verified geolocation identifiers) may be used in combination with the verification of the electronic authorization response to authorize the electronic authorization response. For instance, and based on an authentication of both the electronic authorization response (e.g., like that described above with respect to FIG. 4) and based on the authentication of the geolocation identifier, the authorization system may authorize the electronic authorization response for the electronic copy of the resource distribution instrument.

As shown in block 506, the process flow 500 may include the step of authenticating, based on the comparison of the geolocation identifier to the verified geolocation identifier, the electronic authorization response for the resource distribution instrument. In some embodiments, the authorization system may authenticate the electronic authorization response based on the comparison of the geolocation identifier against the verified geolocation identifier(s).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for electronic authorization for transfer of an electronic resource, the system comprising:
a memory device with computer-readable program code stored thereon;
at least one processing device operatively coupled to the at least one memory device and the at least one communication device, wherein executing the computer-readable code is configured to cause the at least one processing device to:
generate an electronic copy of a resource distribution instrument, wherein the resource distribution instrument identifies a recipient account;
transmit an electronic authorization request to a device associated with a resource distribution, wherein the device associated with the resource distribution is a device associated with a recipient user of the recipient user account;
receive an electronic authorization response from the user device associated with the recipient user, wherein the electronic authorization response comprises at least one of an electronic signature or a captured physical characteristic; and
generate an authorization of the resource distribution instrument based on the electronic authorization response.

2. The system of claim 1, wherein the processing device is further configured to:
capture an image of the resource distribution instrument, wherein the capturing of the image of the resource distribution instrument is completed by at least one of the device associated with the recipient user or a resource distribution machine; and
generate, based on the captured image, the electronic copy of the resource distribution instrument.

3. The system of claim 1, wherein the processing device is further configured to:
query, based on the recipient user account, a user account database to determine at least one verified electronic authorization response of the recipient user;
compare the electronic authorization response to the at least one verified electronic authorization response; and
authenticate, based on the comparison of the electronic authorization response to the verified electronic authorization response, the electronic authorization response for the resource distribution instrument.

4. The system of claim 1, wherein the electronic authorization response further comprises a geolocation identifier.

5. The system of claim 4, wherein the geolocation identifier comprises a geolocation of the device associated with the resource distribution at a time when the electronic copy of the resource distribution instrument is generated.

6. The system of claim 5, wherein the processing device is further configured to:
query, based on the recipient user account, a user account database to determine at least one verified geolocation identifier associated with the recipient user;
compare the geolocation identifier to the at least one verified geolocation identifier; and
authenticate, based on the comparison of the geolocation identifier to the verified geolocation identifier, the electronic authorization response for the resource distribution instrument.

7. The system of claim 1, wherein the electronic authorization response is captured by at least one of an imaging device associated with the user device, an imaging device associated with the resource distribution machine, a physical characteristic scanning device associated with the user device, a physical characteristic scanning device associated with the resource distribution machine, a signature application associated with the user device, a signature application associated with the resource distribution machine, or a signature capture device associated with the resource distribution machine.

8. A computer program product for electronic authorization for transfer of an electronic resource, wherein the computer program product comprises at least one non-transitory computer-readable medium having computer-readable program code portions embodied therein, the computer-readable program code portions which when executed by a processing device are configured to cause the processor to:
generate an electronic copy of a resource distribution instrument, wherein the resource distribution instrument identifies a recipient account;
transmit an electronic authorization request to a device associated with a resource distribution, wherein the device associated with the resource distribution is a device associated with a recipient user of the recipient user account;
receive an electronic authorization response from the user device associated with the recipient user, wherein the electronic authorization response comprises at least one of an electronic signature or a captured physical characteristic; and
generate an authorization of the resource distribution instrument based on the electronic authorization response.

9. The computer program product of claim 8, wherein the processing device is further configured to cause the processor to:
capture an image of the resource distribution instrument, wherein the capturing of the image of the resource distribution instrument is completed by at least one of the device associated with the recipient user or a resource distribution machine; and
generate, based on the captured image, the electronic copy of the resource distribution instrument.

10. The computer program product of claim 8, wherein the processing device is further configured to cause the processor to:
query, based on the recipient user account, a user account database to determine at least one verified electronic authorization response of the recipient user;
compare the electronic authorization response to the at least one verified electronic authorization response; and
authenticate, based on the comparison of the electronic authorization response to the verified electronic authorization response, the electronic authorization response for the resource distribution instrument.

11. The computer program product of claim 8, wherein the electronic authorization response further comprises a geolocation identifier.

12. The computer program product of claim 11, wherein the geolocation identifier comprises a geolocation of the device associated with the resource distribution at a time when the electronic copy of the resource distribution instrument is generated.

13. The computer program product of claim 12, wherein the processing device is further configured to cause the processor to:
query, based on the recipient user account, a user account database to determine at least one verified geolocation identifier associated with the recipient user;
compare the geolocation identifier to the at least one verified geolocation identifier; and
authenticate, based on the comparison of the geolocation identifier to the verified geolocation identifier, the electronic authorization response for the resource distribution instrument.

14. The computer program product of claim 8, wherein the electronic authorization response is captured by at least one of an imaging device associated with the user device, an imaging device associated with the resource distribution machine, a physical characteristic scanning device associated with the user device, a physical characteristic scanning device associated with the resource distribution machine, a signature application associated with the user device, a signature application associated with the resource distribution machine, or a signature capture device associated with the resource distribution machine.

15. A computer-implemented method for electronic authorization for transfer of an electronic resource, the computer-implemented method comprising:
generating an electronic copy of a resource distribution instrument, wherein the resource distribution instrument identifies a recipient account;
transmitting an electronic authorization request to a device associated with a resource distribution, wherein the device associated with the resource distribution is a device associated with a recipient user of the recipient user account;
receiving an electronic authorization response from the user device associated with the recipient user, wherein the electronic authorization response comprises at least one of an electronic signature or a captured physical characteristic; and
generating an authorization of the resource distribution instrument based on the electronic authorization response.

16. The computer implemented method of claim 15, further comprising:
capturing an image of the resource distribution instrument, wherein the capturing of the image of the resource distribution instrument is completed by at least one of the device associated with the recipient user or a resource distribution machine; and
generating, based on the captured image, the electronic copy of the resource distribution instrument.

17. The computer implemented method of 15, further comprising:
querying, based on the recipient user account, a user account database to determine at least one verified electronic authorization response of the recipient user;
comparing the electronic authorization response to the at least one verified electronic authorization response; and
authenticating, based on the comparison of the electronic authorization response to the verified electronic authorization response, the electronic authorization response for the resource distribution instrument.

18. The computer implemented method of 15, wherein the electronic authorization response further comprises a geolocation identifier.

19. The computer implemented method of claim 18, wherein the geolocation identifier comprises a geolocation of the device associated with the resource distribution at a time when the electronic copy of the resource distribution instrument is generated.

20. The computer implemented method of claim 19, further comprising:
querying, based on the recipient user account, a user account database to determine at least one verified geolocation identifier associated with the recipient user;
comparing the geolocation identifier to the at least one verified geolocation identifier; and
authenticating, based on the comparison of the geolocation identifier to the verified geolocation identifier, the electronic authorization response for the resource distribution instrument.
